(19) United States
(12) Patent Application Publication
(10) Pub. No.: US 2010/0264865 A1
(43) Pub. Date: Oct. 21, 2010

(54) DRIVE SYSTEM AND ASSOCIATED CONTROL METHOD

(75) Inventor: Mark-Matthias Bakran, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, Muenchen (DE)

(21) Appl. No.: 12/747,637

(22) PCT Filed: Sep. 8, 2008
(86) PCT No.: PCT/EP2008/061876

§ 371 Date: Jun. 11, 2010

(30) Foreign Application Priority Data
Dec. 14, 2007 (DE) 10 2007 060 188.5

(51) Int. Cl. H02H 7/08; H02P 6/14

(52) U.S. Cl. 318/400.21; 318/400.26

(57) ABSTRACT

A drive system for a permanently excited synchronous machine includes a drive converter, and a control device, wherein terminals of the synchronous machine are connected to corresponding outputs of the drive converter by connecting lines. Controllable asymmetrically blocking semiconductor switches are arranged in each of the connecting lines, with each switch having a thyristor connected in parallel with a reverse-biased diode, with anodes of the thyristors and cathodes of the diodes connected together to corresponding terminals of the synchronous machine. A control device has an input receiving a fault signal and an output connected to control inputs of the drive converter. The control device further includes control outputs connected to control inputs of the semiconductor switches. An easily controlled protective circuit for the drive converter of the drive system is obtained.

The invention relates to a drive system comprising a drive converter, a permanent-magnet synchronous machine and a control device, wherein the permanent-magnet synchronous machine, on the terminal side, is electrically conductively connected by means of connecting lines to outputs of the drive converter, wherein a respective semiconductor switch is arranged in at least two connecting lines, which semiconductor switches, on the control side, are in each case linked to a control output of the control device, and wherein the control device is connected to a fault output on the input side and to control inputs of the drive converter on the output side, and to a method for controlling this drive system.

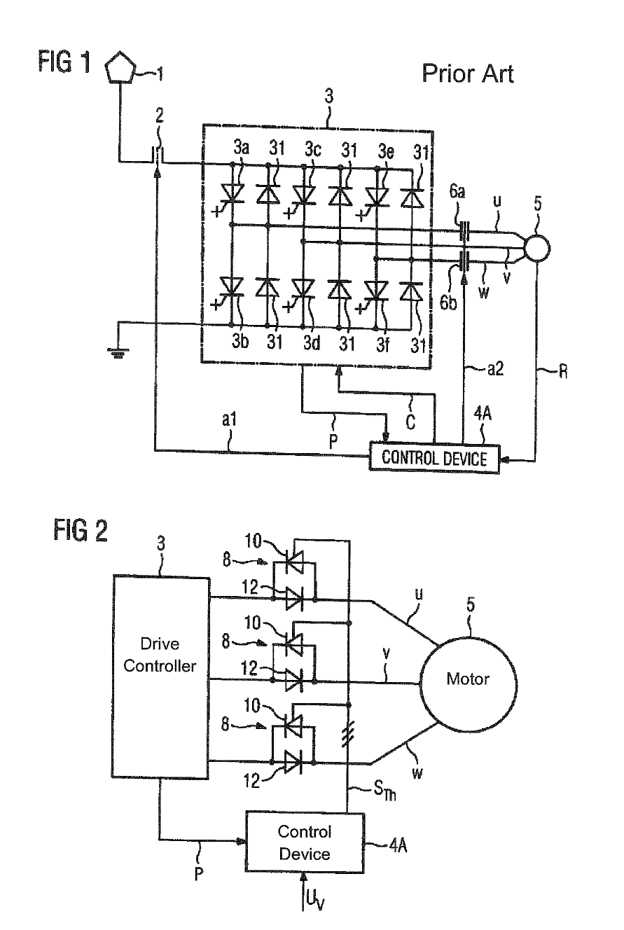

A drive system of the generic type is known from EP 0 718 143 A1, in particular FIG. 1. The drive system will be described in greater detail with reference to said FIG. 1. In FIG. 1, a drive converter is designated by 3, a permanent-magnet synchronous machine is designated by 5, a control device is designated by 4A, and the switches in at least two connecting lines u and w are designated by 6a and 6b. The drive converter 3 provided is a self-commutated pulse-controlled converter having, as converter valve, in each case a parallel circuit formed by a turn-off thyristor 3a, 3b, 3c, 3d, 3e and 3f and a freewheeling diode 31. Each freewheeling diode 31 is electrically reverse-connected in parallel with a turn-off thyristor 3a, 3b, 3c, 3d, 3e and 3f. The turn-off thyristors 3a, 3b, 3c, 3d, 3e and 3f are also known as GTO thyristors (Gate Turn-Off thyristors). The drive converter 3 is operated as an inverter in the drive system in FIG. 1, such that, from a DC voltage present on the DC voltage side, three AC voltages are generated on the AC voltage side.

On the output side, the control device 4A is linked to control inputs of the drive converter 3 and of the two switches 6a and 6b. On the input side, said control device 4A is connected firstly to a sensor (not illustrated more specifically) mounted in the drive converter 3, and secondly to a rotor position transmitter (not illustrated more specifically). As a result, a signal P from the drive converter 3 and a signal R from the rotor position transmitter pass to the control device 4A. Said control device 4A generates control signals C for the turn-off thyristors 3a, 3b, 3c, 3d, 3e and 3f of each converter valve of the drive converter 3 and control signals a2 for the two switches 6a and 6b.

On the DC voltage side, said drive converter 3 is electrically conductively connected to a current collector 1 via a power contactor 2 on the positive side and to a reference potential (ground potential) on the negative side. This drive system illustrated is a drive system for an electric vehicle, in particular a rail-type vehicle.

As soon as one or more turn-off thyristors 3a, 3b, 3c, 3d, 3e and/or 3f have a malfunction, this drive converter can no longer offer a clamping voltage for the permanent-magnet synchronous machine 5. Since the permanent-magnet synchronous machine 5 is a drive motor, for example of a railroad vehicle, and this vehicle continues to move, said permanent-magnet synchronous machine 5 is operated as a generator. As a result, the permanent-magnet synchronous machine 5 in the operating mode “generator” drives a short-circuit current through the connected connecting lines u, v and w and the corresponding semiconductors 3a, 3b, 3c, 3d, 3e and 3f of the converter valves of the drive converter 3. As a result, said semiconductors 3a, 3b, 3c, 3d, 3e and 3f and the permanent-magnet synchronous machine 5 are impermissibly heated.

In order that no short-circuit current can flow in the manner indicated, the two switches 6a and 6b are arranged in the connecting lines u and w. As soon as a semiconductor 3a, 3b, 3c, 3d, 3e and 3f of a converter valve of the drive converter 3 has a malfunction, this state is reported by means of the signal P to the control device 4A. The latter thereupon generates a signal a2 by means of which the switches 6a and 6b, which are closed during normal operation, are opened.

It can additionally be gathered from EP 0 718 143 A1 cited that semiconductor switches can also be provided as switches 6a and 6b. However, the way in which such a semiconductor switch can be constructed cannot be gathered from the published European Patent Application cited.

The invention is based on the object, then, of specifying an embodiment of these semiconductor switches, whereby a protection circuit that can be controlled in a simple manner is obtained for the drive converter of this drive system.

This object is achieved by means of the features of the characterizing part of claim 1.

By virtue of the fact that the semiconductor switch provided is in each case a controllable asymmetrically blocking semiconductor switch, arranged in all the connecting lines between the drive converter and the permanent-magnet synchronous machine, only one control signal has to be generated, which is fed to all the semiconductor switches.

If a thyristor with diode reverse-connected in parallel is provided as the controllable asymmetrically blocking semiconductor switch, then the control is simplified in such a way that a control signal no longer has to be generated in the case of a fault. As soon as a current flowing through a thyristor that is turned on but no longer being driven passes through zero, this thyristor turns off and interrupts an associated current path. Consequently, no losses arise in the controllable asymmetrically blocking semiconductor switches in the case of a fault.

In one advantageous embodiment of the drive system, the controllable asymmetrically blocking semiconductor switches present are arranged in the drive converter, in particular are thermally conductively connected to the cooling system of said drive converter. The cooling of the semiconductors of each controllable asymmetrically blocking semiconductor switch is thus ensured.

The use of a thyristor and a diode reverse-connected in parallel therewith as a controllable asymmetrically blocking semiconductor switch means that only a periodic driving signal is required for the thyristor. In normal operation, the thyristor is turned on, such that said thyristor is in the conducting state for each negative half-cycle of the clamping voltage and the associated diode reverse-connected in parallel is in the conducting state for each positive half-cycle of said clamping voltage. In other words, the connecting lines between the drive converter and the permanent-magnet synchronous machine which have a controllable asymmetrically blocking semiconductor switch are through-connected. In the case of a fault, it is necessary to ensure that the permanent-magnet synchronous machine in the operating mode “generator” can no longer drive a short-circuit current in the connecting lines to the drive converter and back to the permanent-magnet synchronous machine. This is achieved by merely stopping the periodic driving signal for the thyristors of the controllable asymmetrically blocking semiconductor switches arranged in each connecting line. In the simplest case, said periodic driving signal is not actually generated at all in the case of a fault. If a turned-on thyristor of each controllable asymmetrically blocking semiconductor switch present is no longer driven, then the latter turns off as soon as a current flowing through said thyristor passes through zero. Consequently, a protection circuit which can be controlled in a very simple manner is obtained for the drive converter.

For further explanation of the invention reference is made to the drawing which schematically illustrates an embodiment of a drive system according to the invention.

FIG. 1 shows a block diagram of a known drive system and

FIG. 2 illustrates a block diagram of a drive system according to the invention.

In comparison with the embodiment in accordance with FIG. 1, the embodiment of the drive system according to the invention as shown in FIG. 2 has controllable asymmetrically blocking semiconductor switches 8 as semiconductor switches. Each controllable asymmetrically blocking semiconductor switch 8 has a thyristor 10 and a diode 12 reverse-connected in parallel with the thyristor 10. Said controllable asymmetrically blocking semiconductor switch 8 is in each case arranged into a connecting line u, v or w between the drive converter 3 and the permanent-magnet synchronous machine 5 in such a way that the diode 12 is in the conducting state for positive half-cycles and the thyristors 10 are in the conducting state for negative half-cycles of the clamping voltage generated by the drive converter 3.

During fault-free operation of the drive converter 3, the thyristors 10 of the controllable asymmetrically blocking semiconductor switches 8 are driven periodically. For this purpose, a driving signal S_{Th} is generated in the control device 4A. As a result of this periodic driving of each thyristor 10, the drive converter 3 is electrically conductively connected to the permanent-magnet synchronous machine 5. In the case of a fault, that is to say that the drive converter 3 generates a fault signal P, the driving signals S_{Th} of the thyristors 10 are suppressed, such that said thyristors 10 turn off upon the next zero crossing of the current flowing through. The driving signals S_{Th} are suppressed by virtue of the fact that they are no longer generated in the case of a fault. As a result of the turn-off of the thyristors 10 of all the controllable asymmetrically blocking semiconductor switches 8 in the connecting lines u, v and w a current path which can carry a short-circuit current from the permanent-magnet synchronous machine 5 to the drive converter 3 and back to the synchronous machine 5 no longer exists. In the case of a fault, in the configuration of the semiconductor switches according to the invention, a control signal is no longer required in order to switch off said semiconductor switches.

In accordance with FIG. 2, the drive device 4A is fed a supply voltage U_{V}. The latter may fail sometime for whatever reasons. Even in this case, the thyristors 10 are no longer driven with a periodic driving signal S_{Th} since the control device 4A is not ready for operation owing to the absent supply voltage U_{V}. Consequently, the protection circuit of this drive system automatically changes over to the safe state (isolation of the drive converter 3 and the permanent-magnet synchronous machine 5).

Since said thyristors 10 of the controllable asymmetrically blocking semiconductor switches 8 present are turned on only in disturbance-free operation of the drive converter 3, losses arise only during disturbance-free operation of the drive converter 3. In order to cool said thyristors 10, the latter are integrated in the drive converter 3. In other words, said thyristors 10 are thermally conductively connected to the cooling system, in particular the heat sink, of the converter valves of the drive converter 3. This ensures the cooling of the controllable asymmetrically blocking semiconductor switches 8 in regular operation of the drive system. In the case of a fault in the drive converter 3, which may also be a cooling failure, no losses arise in the protection circuit.

What is claimed is:

1.-6. (canceled)

7. A drive system, comprising:
a drive converter,
a permanent-magnet synchronous machine electrically connected to outputs of the drive converter by connecting lines,
a plurality of controllable asymmetrically blocking semiconductor switches arranged in one-to-one correspondence in the connecting lines, each switch comprising a thyristor connected in parallel with a reverse-biased diode, wherein an anode of the thyristor and a cathode of the diode of each switch are connected together to a corresponding terminal of the permanent-magnet synchronous machine, and
a control device comprising an input receiving a fault signal and an output connected to control inputs of the drive converter, the control device further comprising control outputs connected to control inputs of the semiconductor switches.

8. The drive system of claim 7, wherein the asymmetrically blocking semiconductor switches are arranged inside the drive converter.

9. The drive system of claim 8, wherein the asymmetrically blocking semiconductor switches are connected for heat transfer to a cooling system of the drive converter.

10. A method for controlling a drive system with a drive converter, a permanent-magnet synchronous machine electrically connected to outputs of the drive converter by connecting lines, a plurality of controllable asymmetrically blocking semiconductor switches arranged in one-to-one correspondence in the connecting lines, each switch comprising a thyristor connected in parallel with a reverse-biased diode, wherein an anode of the thyristor and a cathode of the diode of each switch is connected to a corresponding terminal of the permanent-magnet synchronous machine, and a control device comprising an input receiving a fault signal and an output connected to control inputs of the drive converter, the control device further comprising control outputs connected to control inputs of the semiconductor switches, the method comprising periodically driving each thyristor of the asymmetrically blocking semiconductor switches during operation of the drive converter.

11. The method of claim 10, wherein if the drive converter experiences a fault, the thyristors of the asymmetrically blocking semiconductor switches are no longer driven.
